(19) United States
(12) Patent Application Publication
(10) Pub. No.: US 2020/0117795 A1
(43) Pub. Date: Apr. 16, 2020

(54) SYSTEM AND METHOD FOR GENERATING AND AUTHENTICATING A TRUSTED POLYMORPHIC AND DISTRIBUTED UNIQUE HARDWARE IDENTIFIER

(71) Applicant: KameleonSec Ltd., Caesaria (IL)

(72) Inventors: Efi SASSON, Kfar Tavor (IL); Jorge MYSZNE, Mountain View, CA (US); Ronen TANNE, Vancouver (CA)

(73) Assignee: KameleonSec Ltd., Caesaria (IL)

(21) Appl. No.: 16/654,410

(22) Filed: Oct. 16, 2019

Related U.S. Application Data
(60) Provisional application No. 62/746,428, filed on Oct. 16, 2018.
(60) Provisional application No. 62/746,436, filed on Oct. 16, 2018.

(51) Int. Cl. G06F 21/45; G06F 21/44; H04L 9/32; G06F 21/64

(52) U.S. Cl. CPC G06F 21/45; G06F 21/44; H04L 2209/16; G06F 21/64; H04L 2209/38; H04L 9/3278

(57) ABSTRACT

A system and method for the generation of a trusted polymorphic and distributed unique hardware identifier (ID) are provided. The method includes checking a device for a current ID; selecting a polymorphic policy setting randomly when no current ID is detected, wherein the polymorphic policy setting defines a functionality of at least one function of the device; selecting functional steps of the at least one function randomly, wherein the functional steps are selected from a number of states of a finite-state machine (FSM) used to construct the at least one function; pairing an output DNA mechanism to the at least one function; and generating the unique ID based on the paired DNA mechanism, its structure and its functional operation.

### CROSS-REFERENCE TO RELATED APPLICATIONS

This application claims the benefit of U.S. Provisional Application Nos. 62/746,428 and 62/746,436, both filed on Oct. 16, 2018. The contents of the aforementioned applications are hereby incorporated by reference.

### TECHNICAL FIELD

The present disclosure relates generally to cybersecurity and more specifically to the field of hardware devices and chip designs regarding the security, authentication, and identification of such devices and systems using such devices.

### BACKGROUND

Today's hardware devices are used for security-critical tasks, either as stand-alone devices or as hardware functions inside a more general-purpose device. Uses for these security-critical devices fall along a broad range, including access control management, security for sensors, wearables and other IoT devices, automotive applications, infrastructure systems, servers, data centers, and the like. These devices and secure functions executed thereon are used to access, generate, and process security and privacy data information.

In order to ensure the security of such systems, two main elements are required: identification and authentication. Identification is the process of recognizing an identity of a user or a system that is seeking access, interact or operate with a device, and authentication is the process of verifying that identity. For example, a server may be configured to verify the identities of its users by using evidence, either provided by the user or retrieved from another source, to establish their identity. In addition to authenticating users, the specific hardware used for various security systems and functions is often critical in executing various security tasks, such as accessing secure networks and encrypting or decrypting sensitive files. Therefore, identifying and authenticating the hardware itself to ensure no malware is being used is desirable. With the increasing amount of security-critical services and systems, there is a growing need for techniques that identify and authenticate the hardware devices used inside such secure systems.

Some of today's evolving security flows incorporate the use of physical unclonable functions (PUF). A PUF is a “digital fingerprint” that serves as a unique identity for a semiconductor device such as a microprocessor. They are based on physical variations which naturally occur during a semiconductor's manufacturing that can be used to differentiate between otherwise identical semiconductors. A PUF can therefore be relied on to create a unique identification (ID) of a hardware device or to generate a device-specific secure key. These unique IDs and secure keys are often used in cryptography and similar high security applications.

Current PUF designs are discrete, deterministic, and passive primitive building blocks that receive homogenous control triggers and challenges and return a response which is passively related to a silicon coordinate where the PUF is physically located. The responses of current PUF designs are not related to the device (or chip) functions, architecture, and operation modes, neither at run time operational mode nor at rest. Thus, the same challenges presented to a particular device will always return the same response regardless the device or its operation mode.

Using such PUF elements has been proven to be insecure. PUF weakness studies have been performed by using machine learning techniques to predict the behavior of PUFs after a certain number of prior challenges and responses have been observed. Research has further shown that delay-based PUF implementations are vulnerable to side channel attacks.

In addition to non-invasive approaches, such as modeling and side channel attacks, there are other hardware related attacks that a PUF may be vulnerable to. These include differential power analysis (DPA) attacks, probing, and the like, which make the current PUF design vulnerable and prone to exploits of various kinds. While a PUF is based on a passive logic, it often requires an additional logic to operate or mange the PUF in the form of software or hardware, which both may be vulnerable to logical memory corruption attacks related to software logic, DPA side channel attacks, or fault injections attacks in case of a passive and deterministic hardware or software logic.

Mounting an effective defense from such attacks is especially critical when there is a need to protect security-critical systems, such as enterprise, industrial, automotive, governmental, and similar critical infrastructure systems.

It would therefore be advantageous to provide a solution that would overcome the deficiencies noted above.

### SUMMARY

A summary of several example embodiments of the disclosure follows. This summary is provided for the convenience of the reader to provide a basic understanding of such embodiments and does not wholly define the breadth of the disclosure. This summary is not an extensive overview of all contemplated embodiments, and is intended to neither identify key or critical elements of all embodiments nor to delineate the scope of any or all aspects. Its sole purpose is to present some concepts of one or more embodiments in a simplified form as a prelude to the more detailed description that is presented later. For convenience, the term “certain embodiments” may be used herein to refer to a single embodiment or multiple embodiments of the disclosure.

Certain embodiments disclosed herein include a method for the generation of a trusted polymorphic and distributed unique hardware identifier (ID), including: checking a device for a current ID; selecting a polymorphic policy setting randomly when no current ID is detected, wherein the polymorphic policy setting defines a functionality of at least one function of the device; selecting functional steps of the at least one function randomly, wherein the functional steps are selected from a number of states of a finite-state machine (FSM) used to construct the at least one function; pairing an output DNA mechanism to the at least one function; and generating the unique ID based on the paired DNA mechanism, its structure and its functional operation.

Certain embodiments disclosed herein also include a non-transitory computer readable medium having stored thereon instructions for causing a processing circuitry to perform a process, the process including: checking a device for a current ID; selecting a polymorphic policy setting randomly when no current ID is detected, wherein the polymorphic policy setting defines a functionality of at least one function of the device; selecting functional steps of the at least one function randomly, wherein the functional steps are selected from a number of states of a finite-state machine (FSM) used to construct the at least one function; pairing an output DNA mechanism to the at least one function; and generating the unique ID based on the paired DNA mechanism, its structure and its functional operation.

Certain embodiments disclosed herein also include a system for the generation of a trusted polymorphic and distributed unique hardware identifier (ID), comprising, including: a processing circuitry; and a memory, the memory containing instructions that, when executed by the processing circuitry, configure the system to: check a device for a current ID; select a polymorphic policy setting randomly when no current ID is detected, wherein the polymorphic policy setting defines a functionality of at least one function of the device; select functional steps of the at least one function randomly, wherein the functional steps are selected from a number of states of a finite-state machine (FSM) used to construct the at least one function; pair an output DNA mechanism to the at least one function; and generate the unique ID based on the paired DNA mechanism, its structure and its functional operation.

### BRIEF DESCRIPTION OF THE DRAWINGS

The subject matter disclosed herein is particularly pointed out and distinctly claimed in the claims at the conclusion of the specification. The foregoing and other objects, features, and advantages of the disclosed embodiments will be apparent from the following detailed description taken in conjunction with the accompanying drawings.

FIG. 1 is a schematic illustration of a polymorphic mutable distributed hardware function.

FIG. 2 is a schematic diagram of an ID entanglement of the DNA mechanism.

FIG. 3 is a diagram of the entanglement of different DNA functions inside a device.

FIG. 4 is a flowchart illustrating a method for generating a unique ID according to an embodiment.

FIG. 5 is a schematic diagram for generating a unique ID to a distributed network according to an embodiment.

FIG. 6 is a network of devices, each having a unique ID/DNA combination.

FIGS. 7A and 7B show schematic diagrams of the distribution of and search for the unique ID of a finite state machine (FSM) over a distributed ledger according to an embodiment.

### DETAILED DESCRIPTION

It is important to note that the embodiments disclosed herein are only examples of the many advantageous uses of the innovative teachings herein. In general, statements made in the specification of the present application do not necessarily limit any of the various claimed embodiments. Moreover, some statements may apply to some inventive features but not to others. In general, unless otherwise indicated, singular elements may be in plural and vice versa with no loss of generality. In the drawings, like numerals refer to like parts through several views.

The various disclosed embodiments include a method and system for the generation and or reconstructing of a trusted polymorphic and distributed unique hardware identifier (ID) and the storage of a signature of the unique hardware ID. In an embodiment, the generation of the unique ID is based on distributed polymorphic functions, such as those generated as a mutable physical unclonable function.

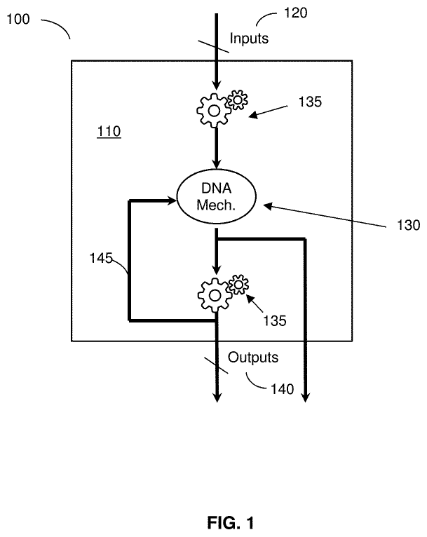

FIG. 1 shows an example schematic illustration of a polymorphic mutable distributed hardware function 100 designed according to an embodiment. The hardware function 110 also referred to as a proactive and intrinsic DNA mechanism 130. The DNA is a physical signature of a device (chip) when a responding to a specific challenge. The polymorphic mutable distributed hardware function 100 is an example of a contextual implementation function of physical unclonable function (PUF). A PUF is a mechanism in which a response to a challenge is dependent on specific physical properties and characteristics of a device, such as a semiconductor of an integrated circuit. These properties are unique and cannot be replicated, even with an otherwise identical chip manufactured from the same source. Thus, a function that is based on these small differences ensures a unique and unclonable response.

The contextual PUF may be based on hardware properties related to transistors, gates, flip-flops, latches, or multiplexers, all of which are hardware logic primitives. These primitives can be used along with hardware structure design to construct a non-deterministic finite-state machine (FSM) of several types, including synchronous or asynchronous FSMs.

The polymorphic mutable distributed hardware function adds to the contextual PUF in that it can produce dynamic structures, functions and results that may change over time, even when produced from the same physical device.

Inputs 120 are received, e.g., from a previous function or a system of a collection of functions, and are sent the DNA mechanism 130. The DNA mechanism 130 is one of multiple functions 135 and logical operations of the device 110 and is embedded within a device 110 or within a function itself. The function may include associated policies, where a policy defines when to activate the distributed polymorphic hardware structure. The result generated from the DNA mechanism 130 are dependent on the current functional state or operational mode of the specific function or device 110, which have different attributes or challenge responses for each operational mode. Each function is configured with a particular purpose tied to one or more operational modes, for example when the device is executing code at runtime or is currently at rest. Operational modes include low power modes, high performance mode, and the like.

The device 110 may include any computing device, but not limited to, a personal computer, a laptop computer, a tablet computer, a server, an IoT device, a computing cloud resource, a network element, a smartphone, an automotive system, an industrial device, an embedded device, and the like. The device 110 may include a chip, a chipset, and the like integrated in any computing device as defined herein.

The results are output 140 from the device 110, e.g., output in text or binary format and sent to the user or to a relevant connected system. In an embodiment, the outputs 140 may be dependent on the DNA mechanism 130 and functions 135 of the device, while in a further embodiment, the outputs 140 are dependent on prior outputs as well, where a first output 140 is fed back 145 to the DNA mechanism 130 to generate a second output.

The challenge response is used to create a unique identification (ID) of the device or to generate a secure key based on that unique ID, which can be correlated to the structure and operation of the intrinsic ID logic.

In an embodiment, a function distributed structure allows for the DNA mechanism 130 to be distributed, i.e., where the DNA generation is spread across a wide physical or logical area. The functional operation of the device 110 itself is dependent on the DNA mechanism 130, making the function modes and operation proactively paired to the specific device.

The implementation of the DNA mechanism 130 is accomplished by following a distributed polymorphic mutable hardware function, such as one with a contextual PUF-like structure, which is embedded inside a logic cone of the function such that it is part of the function and is used to construct the DNA mechanism. Logic cones are logical structures of a function, such as various predetermined combinations of gates, flip-flops, latches, multiplexers, and FSM elements. This mechanism provides runtime challenges and returns responses based thereon. This mechanism can further be implemented either by a register-transfer level (RTL) representation of a contextual PUF, an embedded analog or hard macro function, or by similar silicon or chip design methods.

The polymorphic and distributed nature of the ID generation, as well as the hardware function, results in hardware obfuscation of key aspects of security flows and design elements of the device. In addition to creating a unique ID, this makes it practically impossible to track the functionally or the physical properties of the devices, and thus no probing mechanism can attack or spoof the secured device.

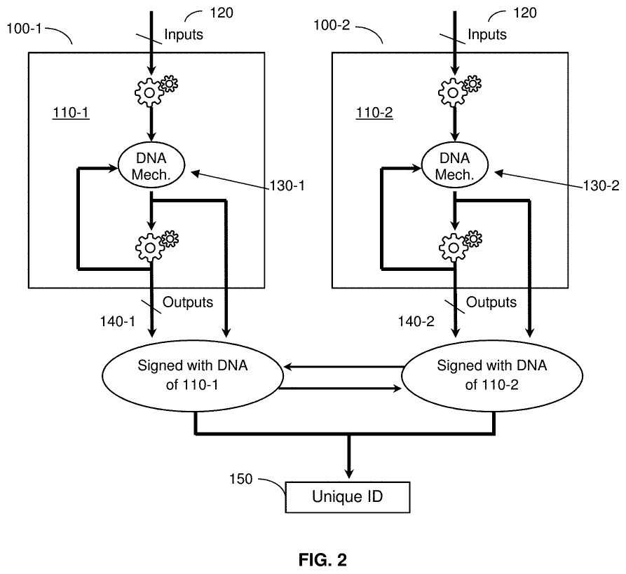

FIG. 2 shows an example schematic diagram of an ID entanglement of the DNA mechanism of two devices 110-1 and 110-2 according to an embodiment. In this example, the outputs 140-1 and 140-2 of the two DNA mechanisms 130-1 and 130-2 are derived from the same input 120 and are used together to generate a unique ID 150.

The unique ID 150 is generated based on an encrypted, hashed, or combined scrambling of the outputs 140-1 and 140-2. In an embodiment, a first device 110-1 is configured to sign the outputs using both DNA mechanisms 130-1 and 130-2. Alternatively, a function can be distributed over both devices 110-1 and 110-2 so that a single output 140 is generated. In a further embodiment, the first device 110-1 executes only a runtime authentication, while the second device 110-2 executes either a runtime or a rest authentication.

In an embodiment, the unique ID 150 is added to a blockchain element (not shown) to be authenticated by different elements of a connected network before it can be used. Both of the devices 110-1 and 110-2 contain distributed mutated polymorphic hardware functions and the logic cones that generate the DNA mechanism 130 in each of these functions are dynamic, and thus can change over time. In an embodiment, the functions are distributed differently based on each device's policy settings.

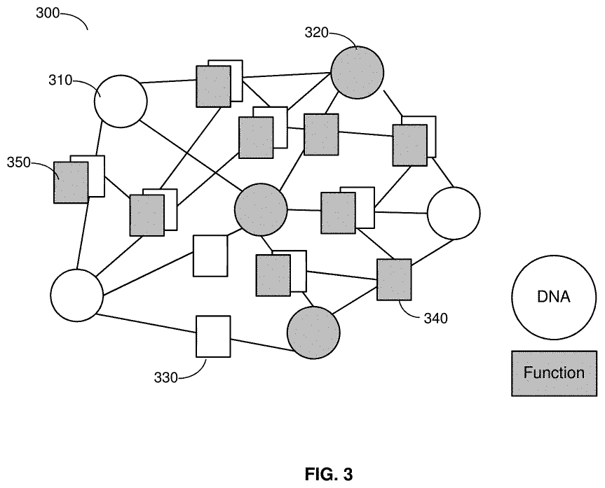

FIG. 3 is an example diagram of the entanglement 300 of different DNA functions 310-350 inside a device, e.g., an FSM. The connectivity and functionality of these functions 310-350 change according to the assigned policy for the device. Thus, each policy results in a different unique ID combination. The unique ID is generated by applying a set of policy rules to the functions 310-350 and a set of functional steps for each function, where the set of functional steps are known as a recipe. A recipe results in the generation of unique information from the function. The unique information is then combined with all the generated unique information from all the functions 310-350 in the device and can be used as a unique ID.

In the example FIG. 3, the circles 310, 320 may represent possible states of a device (e.g., device 110), and the rectangles 330, 340 and 350 represent logic equations where one or more logic equations may be represented as a recipe. An FSM may be configured to use any of the available states or combination of states to generate a unique ID using a distributed polymorphic mutable hardware function based on each of the possible states and logic equations.

An FSM is configurable, depending on various logic cones and physical primitive building blocks, such as transistors, gates, flip-flops, latches or multiplexers. However, the available configurations of an FSM may be constrained to certain specific activities, e.g., only arithmetic functions or activities with a dedicated tolerance for specific security functions. Thus, even if a constrained FSM is accessed by a malicious entity, such as an outside attacker, the functions that the FSM is capable of executing are limited, providing additional security to the device.

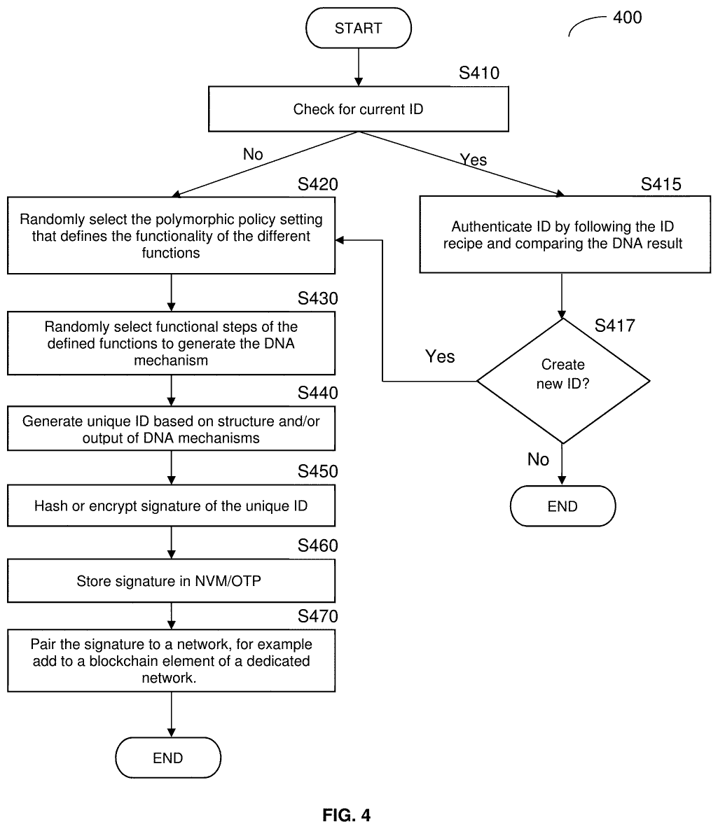

FIG. 4 is an example flowchart 400 illustrating a method for generating a unique ID according to an embodiment. This method includes is an active polymorphic recipe for generating the unique ID. The unique ID is generated by a proactive function or within the same function in proactive way, which can be executed only within a single device or function and according a predetermined recipe. A different recipe results in the generation of a different ID, by different ID structure. Implementing the unique recipe to execute functional polymorphic operations with a DNA mechanism ensures the resulting outputs, e.g., the unique ID, are fully polymorphic and proactive.

At S410, it is determined if a device has an existing current ID. The determination is made when the device is powered on as it completes an internal reset. If no current ID is detected, the method continues at S420, otherwise it continues at S415. The current ID can be detected and verified by, for example, searching for a signature associated with the ID, which may be stored either in an encrypted or hashed state, or in plaintext. The signature may be stored over a distributed ledger, such as blockchain in a database, and the like. An embodiment for storing the signature is a ledger is further discussed below.

At S415, when it is determined that the device does contain a current ID, properties of that ID are retrieved and used to authenticate the device itself against the current ID. In an embodiment, the authentication is accomplished by regenerating an ID following a predetermined recipe and comparing the resulting ID with the current ID.

In an optional embodiment, at S417, a signature of the current ID is generated and compared to a stored signature to determine a match. If there is a match, the authentication is complete. If a match is not produced, the authentication has failed, and a new unique ID may be generated, and execution processed to S420. Alternatively, an alert may be triggered indicating about the failed authentication.

At S420, if a current ID does not exist, a polymorphic policy related to functions of the device is randomly selected, where the polymorphic policy defines a specific functionality for each function of the device to be executed. For example, a polymorphic policy may configure the device to operate as a counter rather than, for example, as an arithmetic logic unit (ALU).

At S430, one or more logical steps of the functions to be executed are randomly selected to generate the intrinsic DNA mechanism. In an embodiment, the functional steps are selected from the number of states of an FSM. If the number of states of an FSM varies, the number of possible functional steps vary as well. A DNA mechanism is generated based on the randomly or controlled selected logical steps and will vary accordingly.

At S440, the generated DNA mechanism is intrinsically paired to the relevant functions to generate a proactive unique ID. In an embodiment, the pairing is accomplished using multiple methods, such as concatenating DNAs together, hashing the DNAs, and the like. In an embodiment, the unique ID is generated such that it possesses at least some metadata generated by the function, where the metadata is used for the regeneration of IDs for authentication purposes. The metadata may include policy settings, selected logical steps, and the like. With the stored metadata, the unique ID may be regenerated, but only if done on the same physical device.

At optional S450, the unique ID is obfuscated, e.g., via hashing or encrypting. In an embodiment, a generated signature of the unique ID is stored, e.g., locally or remotely over a distributed ledger, such as a blockchain to ensure a sufficient level of security.

At S460, a signature of the unique ID is generated and stored for future retrieval. The signature may be stored locally or remotely and may be stored in non-volatile memory (NVM), one-time-programmable (OTP), and the like.

At optional S470, the signature is paired to a network, such as a distributed network. In an embodiment, the distributed network is a blockchain, where the signature is distributed across a network where separate devices are implemented as signing devices. This can be executed with additional authentication steps for enhanced security.

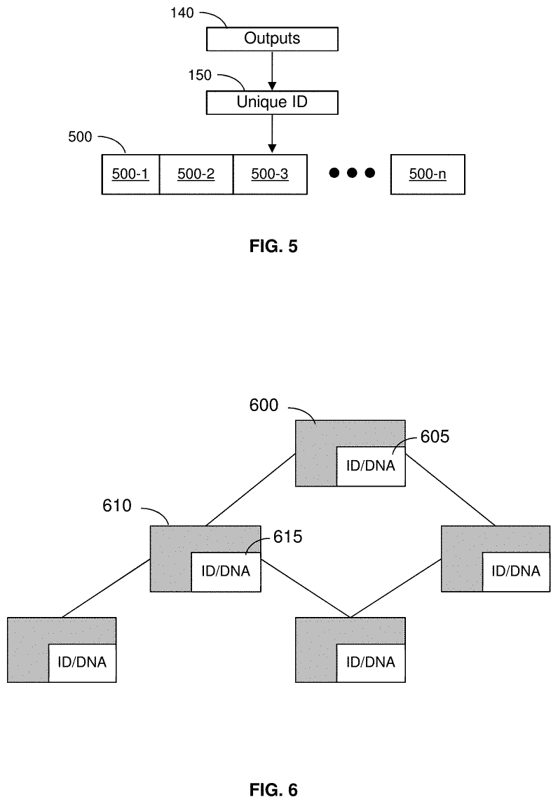

FIG. 5 is an example schematic diagram of generating a generated unique ID 150 and sending a signature thereof to a distributed network 500. The distributed network 500 is made up of multiple nodes 500-1 through 500-n, where n is an integer equal to or greater than 1. In an embodiment, each node may store a separate aspect of the unique ID 150. For example, in a first node 500-1 first part of a signature of the unique ID 150 is stored, in a second node 500-2 a second part of a signature of the unique ID 150 is stored, and in a third node 500-3 metadata associated with the unique ID 150 is stored. In a further embodiment, each aspect of the unique ID 150, such as an alphanumeric representation of the unique ID, its signature, its metadata, an associated recipe, and the like, are split up into multiple parts and distributed among the nodes 500-1 through 500-n of the distributed network 500.

In an embodiment, the unique ID 150 can be also progressively created based on previously generated IDs. For example, a first generated ID can be used as the basis of a second generated ID, the second generated ID can be used as the basis of a third generated ID, and so on. A unique ID can be a concatenation of multiple generated IDs, such that each ID is unique, but based on previously generated ID. This method provides robust protection against ID spoofing, as no one unique ID can be generated, e.g., by a bad actor, on its own without access to previously generated IDs. The series of IDs can also be tokenized and distributed over a distributed network 500.

In an embodiment, the distributed network 500 is a blockchain network, where each node on the network not only stores one or more aspects of the unique ID, but also stores a distributed ledger detailing where signature of each ID can be distributed over the blockchain network. A stored aspect of the signature will only be authenticated if all, or a predetermined threshold, or the nodes confirm the authenticity of the unique ID based on the distributed signatures.

FIG. 6 illustrates a network of devices, each having a unique ID or DNA combination. Each device is assigned an ID and DNA combination, based on the ID generation and DNA mechanism discussed above regarding FIGS. 1 and 2. The signature of the ID may be encoded and the combined result of the challenge response and the unique ID, or the signature of the ID, is stored in a list of signatures of the functions related to the device and the DNA mechanism. A list of signatures can be, for example, inserted into a blockchain, where each element of the block-chain will store part or the entirety of the signature of the unique ID. The signature stored on the blockchain can be fully encrypted, partially encrypted, or stored without any encryption.

In an embodiment, each device of function 600 having a unique ID and DNA mechanism combination 605 is connected to at least one other device of function 610 having its own unique ID and DNA mechanism combination 615.

This unique ID can be authenticated by using one or more randomly selected devices from within the network to execute the authentication process, allowing for a distributed authenticating mechanism. This authentication can be done on the device or function level, where each hardware function is authenticated to ensure no tampering, fibbing, side channel, reverse engineering or other attack was done on any of the devices of associated functions. In a further embodiment, this is done at both the device and the network level to authenticate each of the devices or device functions on the network.

In an embodiment, when the device identify an existing ID at the wake-up process, that device may be configured to start a self-authenticating flow that follows a recipe of the blockchain elements, which includes comparing the outcome of the DNA mechanisms within the devices. Should the device's authentication process fail to identify an existing ID, the device can be deactivated, and the rest of the distributed devices receives via the distributed network.

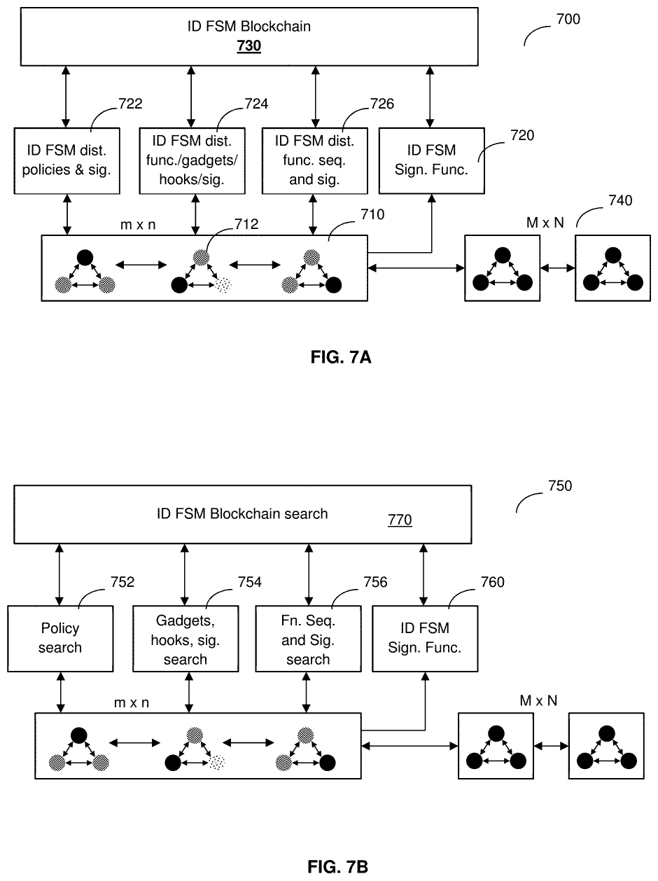

FIGS. 7A and 7B that respectively show schematic diagrams illustrating the distribution of 700 and search 750 the unique ID of a finite state machine (FSM) over a distributed ledger, such as a blockchain. Additionally, not only the unique ID or a signature thereof can be generated and distributed over a blockchain network, but the individual components, such as the functions, gadgets, hooks, policies, sequences, and the like can be distributed over such a network as well.

In FIG. 7A, there is shown the states 712 of an FSM logic 710. The states 712 may include one or more states 712 of an FSM and logical equivalents that may transferred between the states 712. Policies attributed to the FSM are used to describe the structure of the FSM, such as how many states are within the FSM, which cones are within each of the states, the conditions under which a transfer between states occur, and the like.

The states 712 may include gadgets or hooks that connect together to determine the contextual ID for the FSM. This ID may be signed based on the policies of the FSM, the gadgets which describe elements of the FSM stitched together, and functional sequences, e.g., what is input into state, used to operate the FSM.

Each of these states can be used to determine a segment of the unique ID. A segment 722 may contain policies of the unique ID and their signatures. A segment 724 may also contain functions, gadgets, and/or hooks of the unique ID and their signature. A segment 726 may contain functions and sequences of functions of the ID and their signatures. Each segment may be stored on a distributed ledger, such as a blockchain 730, or may be combined together to generate the ID signature function itself 720, which may also be distributed and stored on the blockchain 730.

If the FSM loses power, is rebooted, and the like, the ID can be recreated, authenticated, or checked for integrity by comparing a newly generated signature of the ID with the signature that is distributed and stored on the blockchain 730.

It should be noted that the blockchain stores on the signatures or segments of generated signatures rather than the unique ID itself. The blockchain can be hosted and accessed locally or remotely and may employ proprietary software or implemented on existing blockchain platforms.

The ID can be based on a single FSM and logic, having the resolution of the logic itself (m of n) and can also be stitched together with multiple FSMs and logics (M×N) where many types of FSMs are stitched together to create a new unique ID.

In FIG. 7B, the same mechanism is employed for searching through the blockchain for existing unique ID. As described in steps S410 and S415 of FIG. 4, if a current ID of a device of function is determined to already exist, e.g., if the memory of the device designated to hold an ID is not empty, a search is performed to authenticate the stored ID.

The mechanism described in FIG. 7A is applying, where each of the policies 752, gadgets or hooks 754, functions and their sequences 756 and their respective signatures may be accessed and searched 770 through a distributed ledger 770.

The various embodiments disclosed herein can be implemented as hardware, firmware, software, or any combination thereof. Moreover, the software is preferably implemented as an application program tangibly embodied on a program storage unit or computer readable medium consisting of parts, or of certain devices and/or a combination of devices. The application program may be uploaded to, and executed by, a machine comprising any suitable architecture. Preferably, the machine is implemented on a computer platform having hardware such as one or more central processing units (“CPUs”), a memory, and input or output interfaces. The computer platform may also include an operating system and microinstruction code. The various processes and functions described herein may be either part of the microinstruction code or part of the application program, or any combination thereof, which may be executed by a CPU, whether or not such a computer or processor is explicitly shown. In addition, various other peripheral units may be connected to the computer platform such as an additional data storage unit and a printing unit. Furthermore, a non-transitory computer readable medium is any computer readable medium except for a transitory propagating signal.

As used herein, the phrase “at least one of” followed by a listing of items means that any of the listed items can be utilized individually, or any combination of two or more of the listed items can be utilized. For example, if a system is described as including “at least one of A, B, and C,” the system can include A alone; B alone; C alone; A and B in combination; B and C in combination; A and C in combination; or A, B, and C in combination.

All examples and conditional language recited herein are intended for pedagogical purposes to aid the reader in understanding the principles of the disclosed embodiment and the concepts contributed by the inventor to furthering the art, and are to be construed as being without limitation to such specifically recited examples and conditions. Moreover, all statements herein reciting principles, aspects, and embodiments of the disclosed embodiments, as well as specific examples thereof, are intended to encompass both structural and functional equivalents thereof. Additionally, it is intended that such equivalents include both currently known equivalents as well as equivalents developed in the future, i.e., any elements developed that perform the same function, regardless of structure.

What is claimed is:

1. A method for the generation of a trusted polymorphic and distributed unique hardware identifier (ID), comprising:
checking a device for a current ID;
selecting a polymorphic policy setting randomly when no current ID is detected, wherein the polymorphic policy setting defines a functionality of at least one function of the device;
selecting functional steps of the at least one function randomly, wherein the functional steps are selected from a number of states of a finite-state machine (FSM) used to construct the at least one function;
pairing an output DNA mechanism to the at least one function; and
generating the unique ID based on the paired DNA mechanism, its structure and its functional operation.

2. The method of claim 1, wherein the polymorphic policy defines a specific functionality for each function of the device to be executed.

3. The method of claim 1, further comprising:
generating and storing a signature of the unique ID on a distributed ledger.

4. The method of claim 3, further comprising:
obfuscating the signature of the unique ID before storing it on the distributed ledger.

5. The method of claim 1, wherein checking of the current ID further comprises:
determining at least one of: policies of the FSM and signatures thereof; functions, gadgets and hooks of the FSM and signatures thereof; and functions and sequences of the FSM and signatures thereof.

6. The method of claim 1, wherein the at least one function is a contextual function of a physical unclonable function (PUF).

7. The method of claim 1, wherein the unique ID is further generated based on a concatenation of previously generated IDs.

8. The method of claim 1, wherein the states of the FSM include one or more gadgets or one or more hooks that connect to determine a contextual ID for the FSM.

9. The method of claim 8, wherein at least one of the states of the FSM is used to determine a segment of the unique ID.

10. A non-transitory computer readable medium having stored thereon instructions for causing a processing circuitry to perform a process, the process comprising:
checking a device for a current ID;
selecting a polymorphic policy setting randomly when no current ID is detected, wherein the polymorphic policy setting defines a functionality of at least one function of the device;
selecting functional steps of the at least one function randomly, wherein the functional steps are selected from a number of states of a finite-state machine (FSM) used to construct the at least one function;
pairing an output DNA mechanism to the at least one function; and
generating the unique ID based on the paired DNA mechanism, its structure and its functional operation;

11. A system for the generation of a trusted polymorphic and distributed unique hardware identifier (ID), comprising, comprising:
a processing circuitry; and
a memory, the memory containing instructions that, when executed by the processing circuitry, configure the system to:
check a device for a current ID;
select a polymorphic policy setting randomly when no current ID is detected, wherein the polymorphic policy setting defines a functionality of at least one function of the device;
select functional steps of the at least one function randomly, wherein the functional steps are selected from a number of states of a finite-state machine (FSM) used to construct the at least one function;
pair an output DNA mechanism to the at least one function; and
generate the unique ID based on the paired DNA mechanism, its structure and its functional operation.

12. The system of claim 11, wherein the polymorphic policy defines a specific functionality for each function of the device to be executed.

13. The system of claim 11, wherein the system is further configured to:
generate and storing a signature of the unique ID on a distributed ledger.

14. The system of claim 13, wherein the system is further configured to:
obfuscate the signature of the unique ID before storing it on the distributed ledger.

15. The system of claim 11, wherein the system is further configured to:
determine at least one of: policies of the FSM and signatures thereof; functions, gadgets and hooks of the FSM and signatures thereof; and functions and sequences of the FSM and signatures thereof.

16. The system of claim 11, wherein the at least one function is a contextual function of a physical unclonable function (PUF).

17. The system of claim 11, wherein the unique ID is further generated based on a concatenation of previously generated IDs.

18. The system of claim 11, wherein the states of the FSM include one or more gadgets or one or more hooks that connect to determine a contextual ID for the FSM.

19. The system of claim 18, wherein at least of the states of the FSM is used to determine a segment of the unique ID.

20. The system of claim 11, wherein the FSM is hardware base.
